(19) United States
(12) Patent Application Publication
(10) Pub. No.: US 2015/0168350 A1
(43) Pub. Date: Jun. 18, 2015

(54) METHOD FOR LEAK-TESTING A PLATE HEAT EXCHANGER

(71) Applicant: Société Technique pour l'Energie Atomique Technicatome, Villiers le Bacle (FR)

(72) Inventors: Laurent Jean-Marie Candillier, Simiane-Collongue (FR); Marc Houze, Vallensole (FR); Thomas Mignot, Aix en Provence (FR)

(73) Assignee: Societe Technique pour I'Energie Atomqiue Technicatome, Villiers Ie Bacle (FR)

(21) Appl. No.: 14/411,803

(22) PCT Filed: Jun. 29, 2013
(86) PCT No.: PCT/EP2013/063731

§ 371 Date: Dec. 29, 2014

(30) Foreign Application Priority Data
Jun. 29, 2012 (FR) 12 56282

(51) Int. Cl. G01N 27/90; G01B 7/06; F28D 9/00

(52) U.S. Cl. CPC G01N 27/90; F28D 9/00; G01B 7/10

(57) ABSTRACT

A method for leak-testing a plate heat exchanger is provided. The heat exchanger includes a plurality of primary plates, each primary plate having a long surface in which a plurality of primary channels are bored to ensure the circulation of a primary fluid; a plurality of secondary plates, each secondary plate having a long surface in which a plurality of secondary channels are bored to ensure the circulation of a secondary fluid, the primary and secondary plates being stacked on top of each other alternately. The method includes at least one inspection-testing step during which eddy current testing probes are moved along the primary and/or secondary channels, the primary and secondary plates being diffusion-welded onto each other in such a way that the primary and/or secondary channels have continuous perimeters allowing circulation.

This invention relates generally to plate heat exchangers, and in particular to plate heat exchangers having partitioned channels.

More precisely, the invention relates to a testing method for testing the integrity of a heat exchange zone of a plate heat exchanger, the heat exchanger comprising:
a plurality of first plates, each bearing at least one circulation network for the circulation of a first fluid comprising of a plurality of first channels for circulation of the first fluid;
a plurality of second plates, each bearing at least one circulation network for the circulation of a second fluid comprising of a plurality of second channels for circulation of the second fluid;
   the first and second plates being secured to each other alternately in a sealed manner in order to form the said heat exchange zone of the heat exchanger.

### BACKGROUND

In order to perform a check for leakage in the heat exchange zone of such a heat exchanger it is a known technique to carry out a leakage test by means of the pressurisation of one of the fluid circuits (water, tracer gas) followed by the measuring of flow rate of a possible eventual leakage occurring through the wall. This type of test is a general global test and does not provide the ability to distinguish in particular the micro leaks that may be spread throughout all the plates from a localised larger leak. In addition, they do not provide the ability to detect any cracks or other damage that may have not yet resulted in a leak through the wall (defects in the course of being manifested for example due to corrosion or cracking induced by fatigue).

When the periodic assessment of fitness of the integrity of the exchange wall of such a heat exchanger is required, or when it is necessary to ensure volumetric inspection-testing of the welded joints, it is a known practice to use technologies for demountable assembly types, such as plates and gaskets for example, and to disassemble the heat exchanger in order to carry out a plate by plate examination by means of various appropriate methods (penetrant testing, through light testing, magnetic particle testing, etc). However, for certain heat exchanger technologies based on non-demountable plates (plates that are brazed or edge welded on the rim), it is not possible to perform leak testing on the internal parts of the exchanger. Only testing for leakage between the rims of the plates may be carried out.

### SUMMARY OF THE INVENTION

In this context, a testing method is provided for inspection and testing of the fitness of the integrity of the heat exchange walls of a plate heat exchanger, without disassembly of the plates, thereby providing the ability to anticipate the occurrence of internal leaks within the heat exchanger.

To this end, the testing method includes at least one step of inspection-testing in the course of which eddy current testing probes are moved along the first and/or second channels, the first and second plates being assembled on to each other by diffusion welding in a manner such that the first and/or second channels from which the inspection and tests are carried out have continuous perimeters that enable the circulation of the eddy currents around each of the first and second channels in which the testing probes are moved.

The layout configuration of communication passages between channels carrying the same given fluid may be constituted by the superposition of the first and second channels.

The diffusion welding process is used for welding the plates constituting the heat exchange zone of the heat exchanger to one another both at their periphery, referred to as the rim, as well as at the level of the internal zones separating the channels of the same given plate from each other. These separation zones are known as isthmus. Thus diffusion welding provides the ability to obtain a continuity of the material around each channel from which the testing will be occurring in a manner such that that the eddy currents are able to loop around each channel. Such a continuity of material over the entire periphery of the channels is essential for the interpretation of the testing by means of eddy currents in an axial probe in a manner so as to distinguish the defects that have appeared while in service (such as cracking) from possible eventual weld joint deficiencies inherent in the welding.

This inspection-testing technology is thus not applicable to heat exchangers welded only on the rim (not sufficient intimate contact to allow the closed looping of eddy currents).

The dimensions of the eddy current probes are compatible with the millimetre dimensions of the channels of this type of heat exchangers and to the different cross sections of channels resulting from the manufacturing processes used (parallelepiped or rectangular section obtained by mechanical machining, curved section obtained by chemical machining, section with undercut obtained by drawing). Introduction of the probe is facilitated by tracks of the least curved possible channels (one or two inflections over the length of the channels, with radii of curvature substantially greater than the largest dimension of the section of the channel (factor of 10 or more preferably). By way of example, probes have been developed for the testing of channels having rectangular cross section measuring 4 mm in width by 0.8 mm in depth, and for thicknesses of walls and isthmuses of 1 mm, for lengths of channels of the order of 2.5 m with a radii of curvature of at least 50 mm. The sensitivity achieved makes it possible to search for cracks extending over half the thickness of the wall or the isthmus, for a length of the order of the width measurement of the channel.

The above method is typically intended to be used in a nuclear reactor, in particular in a small or medium size nuclear reactor. It is especially suitable for inspecting and testing the fitness of heat exchange walls of plate heat exchangers, provided for the transfer of heat from the primary fluid of the nuclear reactor to the secondary fluid. The primary fluid is heated by circulation thereof through the core of the nuclear reactor.

Typically, the primary fluid is water and the secondary fluid is also water and/or steam. In this case, the heat exchanger is typically a steam generator. The secondary fluid enters and penetrates into the heat exchanger in the form of liquid. It is vaporised under the effect of the heat given up by the primary fluid and exits the heat exchanger in the form of vapour.

By way of a variant, the primary or secondary fluids are not water. For example, the primary and/or secondary fluids are liquid metals such as sodium, or gases. However, for certain applications, the presence of non-conductive fluid may require the draining and the rinsing of the circuit if the testing is carried out from a circuit carrying a conductive fluid (for example: sodium).

The heat exchanger is typically arranged in the interior of the vessel of a nuclear reactor. This vessel also contains the core of the nuclear reactor and various internal components.

By way of a variant, the plate heat exchanger may not be so located in the vessel of a nuclear reactor but may be interposed in the primary circuit of a nuclear reactor, outside of the vessel or on another circuit of the reactor. The method may also be used in an industrial installation other than a nuclear reactor, the heat exchanger being designed so as to be traversed by any type of liquid or gaseous fluid.

The first and second channels are typically created respectively in the first plates (primarily bearing the channels carrying the first fluid) and in the second plates (primarily bearing the channels carrying the second fluid). They are open at the level of the long surfaces of the first and second plates. In other words, the first and second channels are grooves formed in the mass of the first and second plates. Each of the first and second plates has a first large face in which passages are formed and a second large face free of passages. When the first and second plates are stacked on top of each other in an alternating manner, the second large face of a given plate serves to close the passages of the plate situated immediately below it.

Typically, the first and second channels are created in the first large faces by the removal of material (mechanical machining, chemical machining, etc), hot or cold forming, or by any other equivalent process.

By way of a variant, each plate bears grooves on its two large faces. These grooves coincide with each other when the plates are stacked. The grooves positioned to be facing each other located between two given plates define the first and second channels.

Embodiments of invention are also applicable to heat exchangers including, in addition to the first and second channels, for example channels dedicated to the detection of leakage between the first and second channels, or stages of recirculation.

Typically, a level with the first channels (primary level) is flanked by two levels with second channels (secondary level) and vice versa. By way of a variant, the arrangement involves successive placement of one primary level, two secondary levels, one primary level etc. it is also possible to place two primary levels, two secondary levels and then two primary levels etc. Other configurations may also be envisaged.

In the method, the inspection-testing is carried out only on the first channels, or only the second channels, or on both the first and second channels.

The diffusion welding technique is a solid phase welding process known per se, which will not be described in detail. In this method, the materials to be assembled are heated and then brought into contact under the effect of pressure for a predetermined period of time. This process of bringing about contacting results in a weld joint whose mechanical properties are close to that of the material to be assembled. This process leads to a weld joint having excellent physical and metallurgical continuity at the macroscopic scale of the material.

The diffusion welding presents the advantage that the weld joint has virtually no microporosity or discontinuity. This is particularly important for the conducting of inspection-testing making use of axial eddy current probes.

Testing by means of eddy currents is a process known per se. It will thus not be described in detail here. In this method, the probe moved along the channel to be tested comprises a transmitter coil supplied with power by an alternating electric current. This coil generates a magnetic field that passes through the wall of the channel to be tested. The variations in the magnetic flux in this wall create induced currents known as eddy currents. These eddy currents in turn create a magnetic field, which is sensed by a receiver coil carried by the probe. The receiver coil is either identical to or different from the transmitter coil. The two coils may be carried by the same probe or by separate probes. Absolute probes (one single coil) give the best results for the mild deficiencies or defects (for example: uniform deposits, loss of material) while the differential probes may have a better sensitivity for point defects (for example: shock, crack, etc). In the presence of a deficiency or defect in the wall of the channel, the flow of eddy currents in this wall is disrupted by the variations in electrical conductivity due to the geometry of the defect. This affects the magnetic field created by the eddy currents. The disturbances in the signal are interpreted in order to obtain a representation of the size of the defect. The probes in particular provide the ability to also inspect and test the quality of welding between the plates at the level of the isthmuses, in particular in configurations where the channels of a same given network are arranged on two plates mounted to be facing each other. In a differential sensor, the receiver coil is distinct and separate from the transmitter coil. This type of sensor can also be used in embodiments of invention.

It is to be noted that, due to the fact that the diffusion welding creates weld joints between the plates which are substantially devoid of discontinuities or porosities, the flow of eddy currents, in the absence of deficiencies or defects, is not at all affected by the said weld joints.

The method may also present one or more of the characteristic features outlined here below, considered individually or in accordance with all technically possible combinations.

Advantageously, the first or second channel of a same given plate are separated from each other by continuous isthmuses diffusion welded to another plate.

The isthmuses are ribs defining the partitions between the first or second channels. Thus, the first and second channels are each bounded by two continuous isthmuses. Each isthmus is integrally formed with a plate. It is diffusion welded to another plate, this weld joint being, as emphasised here above, free of any pores or discontinuity. Thus, there is a continuity of material around each first or second channel. Each channel thus constitutes the equivalent of a closed tube.

The existence of voluntary discontinuities within a network of channels, for example balancing related communications between the channels within the same plate, is harmful to the possibility of inspection testing according to embodiments of invention by means of an axial probe. Conversely, the existence of such discontinuities in channels other than those through which the testing is carried out, is not harmful to the testing.

The superposition of the network of first and second channels over the largest possible surface within the heat exchanger facilitates the interpretation of the inspection-testing because the distribution of the material around the channel remains constant and the level of leakage of currents is constant. The non superposition of the networks of first and second channels from one plate to the other, for example in a zone or one of the networks is composed of parallel channels and the other of zig zag channels, introduces variations in the eddy currents due to changes in geometry and makes interpretation of the inspection-testing more difficult.

The diffusion welded plate heat exchanger can thus be likened to a contiguous assembly of tubes mounted side by side.

The method makes it possible to inspect and test the bottoms of channels and the welds of isthmuses, in order to search for the initiation points of cracks or bonding of channels.

The inspection-testing step is performed without the first and second plates being disassembled from each other. In fact, it is not necessary to separate the plates from each other in order to cause the circulating of the eddy current probes and test the integrity of the channels.

Typically, the heat exchanger is mounted in a nuclear reactor, the inspection-testing step being performed in situ. In other words, the inspection-testing step is performed without disassembling the heat exchanger. It is to be noted that the inspection-testing method is applicable:
in factory, at the end of the manufacturing process of the heat exchanger;
in operation, in-situ;
in operation, after disassembly of the heat exchanger.

The practice of carrying out the inspection-testing step in situ is particularly convenient, as the disassembly of the heat exchanger, for its removal from the nuclear reactor, for example, is a long, delicate step and generates biological hazards for the operators involved.

Advantageously, the heat exchanger is mounted in a nuclear reactor, the inspection-testing step being carried out under water. Thus, one can benefit from the fact that water constitutes a protective screen with respect to the radiation, in a manner such that the radiation doses absorbed by the operators during testing operations are greatly reduced.

Preferably, the first and/or second channels each have first and second ends opposite to each other, the heat exchanger having one or more top plane surfaces on which the said first ends open.

The top plane surfaces are typically formed by the edges of the plates, also known as rims, juxtaposed one against the other. The fact that the channels open out on planar zones, known as top plane surfaces, makes it possible to simplify the setting in position and the interfacing between the device used to perform the leak testing and the heat exchanger.

Typically, in the case of inspection-testing done in the workshop or in situ, the heat exchanger is positioned in such a way as to ensure the ease of accessibility of the top plane surface or planes wherein open the channels through which the testing should be performed.

The first ends of the first and/or second channels are preferably arranged so as to form on each top plane surface several rows parallel to each other. This helps to simplify the interfacing between the testing device and the heat exchanger. Typically, each row consists of the ends of the channels arranged in a given plate.

Advantageously, the inspection-testing step is performed by making use of an testing device comprising a chassis mounted on to the heat exchanger, and a plurality of probes connected to the chassis, with the probes performing the simultaneous testing of several channels, for example, of all the first and/or second channels whose first ends are situated in a given row.

Thus, the time required to perform the leakage testing is reasonable since it is possible to test a large number of channels simultaneously.

Typically, the heat exchanger comprises between 10 000 and 100 000 channels which is 5 to 10 times the number of tubes of an equivalent tube heat exchanger (order of magnitude). The testing device typically comprises between 50 and 500 probes.

Preferably, the probes are linked to a support that is movable in relation to the chassis, the support being moved relative to the chassis upon completion of the testing of all of the first and/or second channels whose first ends are situated on a given row, in a manner so as to place the probes in position in order to carry out the testing of all the first and/or second channels whose first ends are situated on another given row.

Thus it convenient process to pass from one row to another.

Advantageously, the chassis of the testing device is positioned relative to the first ends of the first and/or second channels by using positioning indexes formed on each top plane surface.

The positioning indexes facilitate the positioning of the chassis relative to the top plane surface. They thus facilitate the positioning of the probes relative to the first ends.

Advantageously, the first and/or second channels are each delimited by a peripheral wall having, along the entire periphery of the said first or second channel, a substantially constant thickness of material.

The material thickness along the periphery of the first or second channel, varies, for example by less than 20%, preferably by less than 15%.

Thus, the signal from the testing probe is not distorted by variations in thickness of the wall around the channel to be tested. The testing is much more accurate.

For this purpose, the first and second channels advantageously each have a rectangular cross section. The thickness of the isthmuses separating two channels of the same plate is preferably chosen to be substantially equal to the thickness of the bottom separating each channel of a particular given plate from the plate that is immediately above or below.

The thickness of material around each channel is thus very regular. It is slightly larger at the corners of the rectangular section, but this extra thickness remains limited. A variation in thickness of less than 20% was also obtained with other shapes of cross section, for example curved or with undercut.

It is also advantageous that all the channels are parallel to each other. The primary or secondary channels of a same given plate are thus advantageously parallel to each other. The primary or secondary channels of a given plate are parallel to the primary or secondary channels of the plate that is immediately above and to those of the plate that is immediately below.

The thickness of material between the channels is thus constant along the length of these channels. This would not be true if the channels were not parallel to one another.

Preferably, the heat exchanger is secured inside a nuclear reactor vessel comprising a shell, a cover, and a fastening flange for fastening the cover to the shell, the heat exchanger being disposed in the shell in a manner such that each top plane surface is turned towards the flange.

Thus, in order to carry out inspection-testing of the heat exchanger, the cover is detached from the shell. This makes it possible to release an access opening through which the testing device can be brought to the heat exchanger.

The access to the heat exchanger is therefore greatly facilitated.

### BRIEF SUMMARY OF THE DRAWINGS

Other characteristic features and advantages of the invention will clearly become apparent from the detailed description which is given here below, purely by way of information, however without limitation, with reference being made to the accompanying figures in which:

FIG. 1 is a partial representation, of a cross sectional, simplified view of an eddy current testing probe engaged in a primary channel of a plate heat exchanger;

FIG. 2 is a simplified perspective view, of a plate heat exchanger ready to be used for the implementation of the method of an embodiment of invention;

FIG. 3 illustrates in a simplified schematic manner the disposition of a plate heat exchanger in the interior of the vessel of a nuclear reactor, facilitating the implementation of the method of an embodiment of invention;

FIG. 4 is a simplified schematic representation of a testing device provided for the implementation of the method of an embodiment of the invention,

FIG. 5 represents the flow of eddy currents during the course of the inspection-testing method of an embodiment of invention;

FIG. 6 is a view similar to that shown in FIG. 1, illustrating the situation of a plate heat exchanger in which the plates are not diffusion welded; and

FIG. 7 is a view similar to that shown in FIG. 5 illustrating the flow of eddy currents in the heat exchanger shown in FIG. 6.

### DETAILED DESCRIPTION

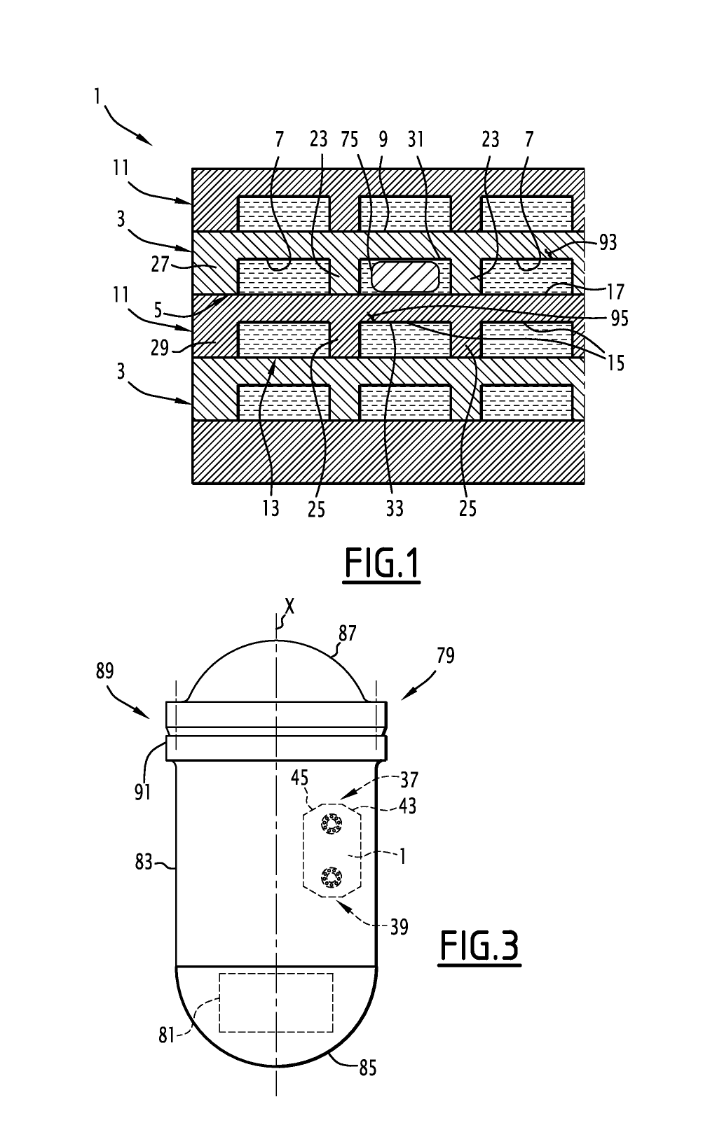

The method to be described here below is designed for performing leak testing of a plate heat exchanger. This heat exchanger is for example a steam generator integrated in the vessel of a nuclear reactor for which it is desired to test the state of fitness of the walls of the heat exchange zone from only the primary channels, the zone being tested representing more than 90% of the heat exchange surface. As illustrated in FIG. 1, the heat exchanger 1 comprises:
a plurality of first plates 3, referred to here, as primary plates, each primary plate 3 having a first large face 5 in which are located a plurality of first channels 7, referred to here as primary channels, provided for the circulation of a first fluid (primary fluid) of the nuclear reactor, and a second large face 9, opposite the first and free of any primary channels,
a plurality of second plates 11, referred to here as secondary plates, each secondary plate 11 having a first large face 13 in which are located a plurality of second channels 15, referred to here, as secondary channels, provided for the circulation of a second fluid (secondary fluid) of the nuclear reactor, and a second large face 17, opposite to the first and free of any secondary channels.

Only two primary plates and two secondary plates are represented in FIG. 1. However, the heat exchanger includes a much higher number of plates.

As seen in this figure, the primary plates 3 and secondary plates 11 are stacked one on top of the other in an alternating manner, each primary plate being flanked by two secondary plates and vice versa.

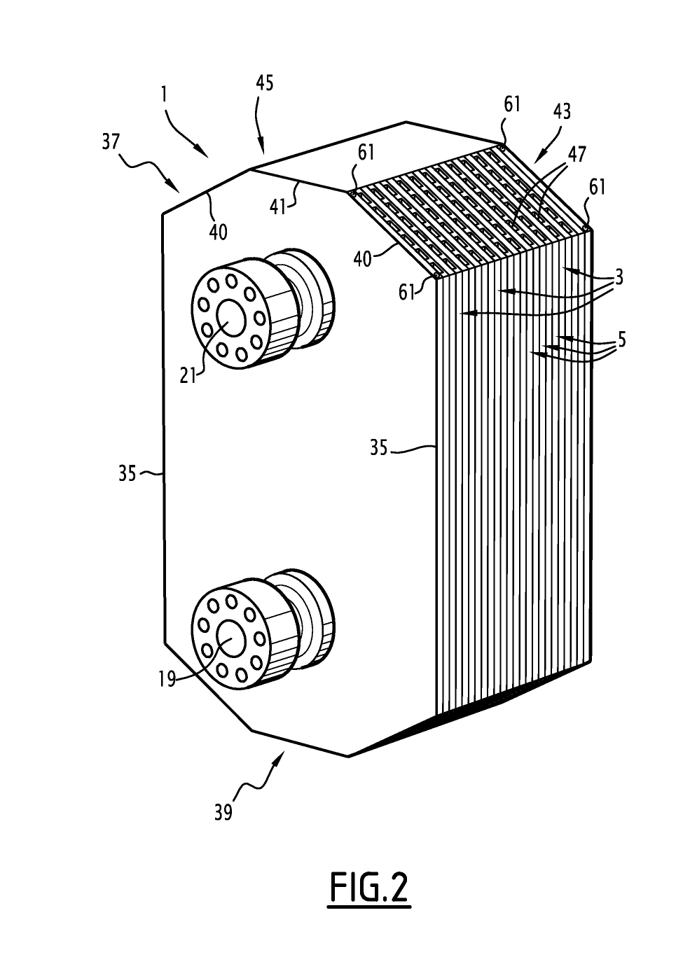

The primary channels 7 are each open at first and second ends opposite to each other. They are open at the first large face 5. Similarly, the secondary channels 15 are each open at their two opposite ends, known as upstream end and downstream end. The upstream end opens in a secondary supply manifold 19, shown in FIG. 2, and the downstream end in a secondary discharge manifold 21 shown in FIG. 2. Each secondary channel 15 is open at the large face 13.

The primary channels 7 are separated from each other by isthmuses 23, formed integrally with the primary plate 3. Similarly, the secondary channels 15 are separated from each other by isthmuses 25 formed integrally with the secondary plates 11.

The isthmuses 23 and 25 are exposed respectively at the large faces 5 and 13 of the primary and secondary plates.

The primary and secondary plates 3 and 11 are stacked in a manner such that the second large face 9 of a given primary plate is applied against the first large face 13 of the secondary plate located immediately above, in the representation of FIG. 1. Similarly, the second large face 17 of each secondary plate is applied against the first large face of the primary plate 5 situated immediately above, in the representation of FIG. 1. Thus, the primary channels are closed at the level of the first large face 5 by the secondary plate situated immediately below. Similarly, the secondary channels 15 are closed at the level of the first large face 13 by the primary plate situated immediately below.

The primary and secondary plates 3 and 11 are welded to each other by diffusion. More specifically, the peripheral rim 27 of each primary plate 3, also known as rim, and the isthmuses 23 of the primary plate are welded by diffusion on the second large face 17 of the secondary plate situated under the primary plate. Similarly, the peripheral rim 29 and the isthmuses 25 of each secondary plate 11 are diffusion welded on to the large face 9 of the primary plate immediately below the secondary plate.

Thus, the primary channels 7 are delimited by a bottom 31 formed in the primary plate, two isthmuses 23 formed in the primary plate and by the large face 17 of the secondary plate immediately below. The primary channels 7 situated on the edges of the plates are delimited by the bottom 31, by an isthmus 23, by a rim 27 and by the large face 17 of the secondary plate immediately below.

The secondary channels 15 are delimited by a bottom 33 formed in the secondary plate, by two isthmuses 25, and by the large face 9 of the primary plate immediately below. The secondary channels situated on the edge of the secondary plates are delimited by an isthmus 25, by a rim 29, by the bottom 33 and by the large face 9 of the primary plate immediately below.

Thus, each of the primary and secondary channels is closed over its entire periphery, and is delimited by different elements having a material continuity with each other.

In addition, the thickness of the wall delimiting each of the primary and secondary channels is substantially constant when one follows the periphery of each of these channels. As illustrated in FIG. 1, the material thickness is greater at the corners of the channels, but this extra thickness is quite modest, and for example amounts to less than 10% of the thickness of the wall at a distance away from the corners. The extra thickness that can possibly be tolerated depends on the size of the defects being sought.

The primary channels 7 and the secondary channels 15 each have a substantially rectangular cross section, which is constant along each channel. The primary channels 7 and the secondary channels 15 are all parallel to each other. Furthermore, the isthmuses 23, 25 separating the primary channels from each other and the secondary channels from each other have substantially the same thickness. These isthmuses 23, 25 have a thickness substantially equal to the thickness of the bottoms of the primary and secondary 3 and 11 plates. The bottom of a plate corresponds to the zone of the plate separating each primary or secondary channel from the channel situated immediately above it or below it, in the upper or lower plate.

As illustrated in FIG. 2, the heat exchanger 1 has a shape elongated along a longitudinal direction. The primary and secondary channels 7 and 15 are substantially parallel to the said longitudinal direction. The heat exchanger 1 is designed to be mounted in the vessel of the nuclear reactor with its longitudinal axis oriented vertically (see FIG. 3).

The primary and secondary plates 3 and 11 all have the same general shape, and are also elongated longitudinally. As shown in FIG. 2, they are delimited by two longitudinal edges parallel to each other 35, an upper edge 37 and a lower edge 39, the upper and lower edges 37 and 39 connecting the two longitudinal edges to each other. The upper edge 37 comprises two sections 40 facing each other, connected to each other by a central section 41. The inclined sections 40 of the various different plates 3 and 11 together define two top plane surfaces 43 and 45, visible in FIG. 3. The top plane surfaces 43 and 45 are substantially planar.

The first ends 47 of the primary channels 7 all open at the level of the top plane 43 and at the top plane surface 45.

When one considers one of the two top plane surfaces 43, 45, it appears that the first ends 47 are arranged in several rows parallel to each other. More precisely, all of the first ends 47 of the primary channels 7 of a given plate opening at the level of the said top plane surface 43, 45 are aligned.

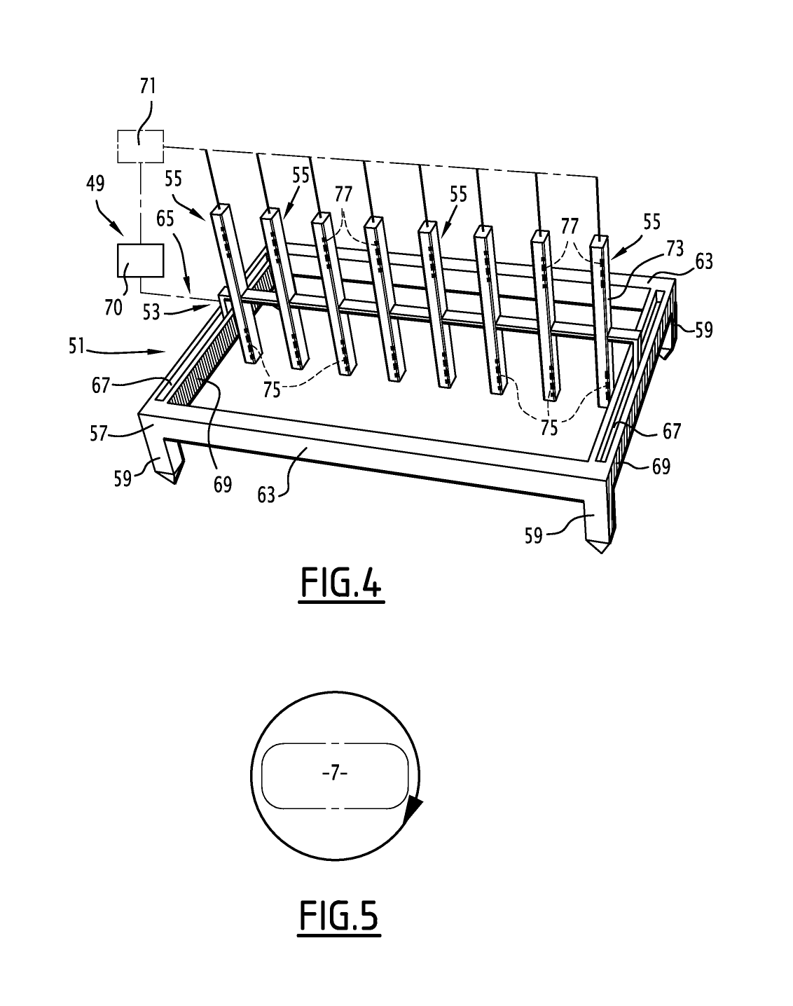

The method is intended to be implemented by making use of the device 49, shown in FIG. 4. The device 49 comprises a chassis 51 designed to be mounted on to the heat exchanger 1, a support 53 movable relative to the chassis, and a plurality of probes 55 mounted on the support 53. The chassis 51 includes a frame 57 and indexing fingers 59 for indexing the frame relative to the heat exchanger. The device further includes the means for securing the chassis 51 in a removable manner to the heat exchanger, which are not represented here.

The fingers 59 are provided so as to cooperate with the positioning indexes 61 provided in each top plane surface 43, 45 (FIG. 2).

The support 53 is for example a small beam, substantially parallel to two of the arms 63 of the frame 57. The device 49 comprises a motorised sliding connection link 65 from the support 53 to the frame 57.

The link 65 includes two slide rails 67 for guiding the support 53, carried by two arms 69 of the frame 57. The arms 69 are perpendicular to the arms 63. The link 65 also includes a motor reducer 70 controlled by a computer 71, provided for driving the support 53 along the slide rails 65. Thus, the support 53 is designed to be moved relative to the chassis 51 along the slide rails 67, with the probes 55, under the control of the computer 71.

The device 49 includes a plurality of eddy current sensors 55 distributed along the support 53.

Each probe 55 has a guide tube 73, a measurement head 75 and a motor 77, that is controlled by the computer 71 and designed to drive the head 75 along the primary and/or secondary channels.

The tubes 73 are rigidly secured to the support 53. They are oriented substantially perpendicularly to the plane of the frame 57. At rest, the heads 75 are retracted within the interior of the tubes 73.

In the example of FIG. 3, the heat exchanger 1 is arranged in the vessel 79 of a nuclear reactor. The vessel 79 has a central vertical axis X. The vessel 79 contains in the lower part the core 81 of the reactor, as well as other internal members that will not be detailed here.

The vessel 79 includes a shell 83, a lower base 85 integrally secured to the shell, and an upper base 87 constituting the cover of the vessel. The shell 83 has a vertical central axis. The lower base 85 is integrally secured to a lower end of the shell 83. The cover 87 is mounted in a removable manner to an upper end of the shell 83 by means of a flange 89.

The heat exchanger 1 is fixed to the shell 83. It is mounted in a manner such that the longitudinal direction is vertically oriented. The top plane surfaces 43 and 45 are thus turned towards the flange 89, in a manner so as to facilitate access to these top plane surfaces when the cover 87 is removed.

The method for inspection-testing of the plate heat exchanger described here above will now be detailed.

The testing is carried out in situ, that is to say, with the heat exchanger in place inside the vessel of the reactor. When the nuclear reactor is stopped, the cover 87 is detached from the shell 83 and removed. The top end 91 of the shell thus delimits an opening to be used for introducing the testing device 49 into the reactor vessel.

The vessel of the reactor is under water, in a manner such that the heat exchanger is immersed in the primary liquid.

The testing device 49 is lowered within the interior of the shell 83 and the chassis 51 is rigidly fixed to the heat exchanger.

The chassis 51 is indexed into position in relation to one of the two top plane surfaces, for example the plane 43, by making use of the fingers 59 cooperating with the positioning indexes 61.

First of all, testing is performed on the primary channels opening at the level of the top plane surface 43.

Making use of the indexing means, the chassis 51 is oriented such that the support 53 is parallel to the first end rows 47. In other words, the support 53 extends parallel to the primary and secondary plates 3 and 11. In contrast, the slide rails 55 extend substantially perpendicular to the first end rows 47. The spacing of the tubes 73 corresponds to the spacing of the first ends along a same row. Once the frame is in place, the lower end of the tubes 73 is situated in the immediate proximity of the top plane surface 43.

The computer 71 subsequently commands the movement of the support 53, in a manner so as to place the tubes 73 in the extension of the first ends of a given row.

The computer 71 then commands the motors 77 to move the measuring heads 75 in the direction of a depression inside the primary channels 7. The heads 75 move from the first end of the primary channels up to the second end of the primary channels. When they reach the second end, the computer 71 commands the motors 77 to reverse the direction of movement of the heads 75 and to bring them back into the tubes 73.

During their movement, the measurement heads 75 emit magnetic waves that create eddy currents in the periphery of the channels being inspected and tested, as shown in FIG. 5. The eddy currents circulate around the primary channel in the process of being inspected. They create induced magnetic fields which are detected by the measuring heads 75.

If one of the channels exhibits an initiation of a crack 95 initiated through the bottom 33 of the secondary channel 93 or initiated through the bottom of the primary channel or a bonding or a loss of thickness or other localised defects of the walls of the channels 5 or 11 such as a puncture, the circulation of eddy currents is disturbed and the induced magnetic field is affected. This modification of the induced magnetic field enables the detection of the initiation of cracks or punctures. Here the term “bonding” is used to refer to a zone of a channel wherein a pinch off effect is produced, the bottom 33/31 of the channel for example being caused to touch the long surface 9/17 of the neighbouring plate.

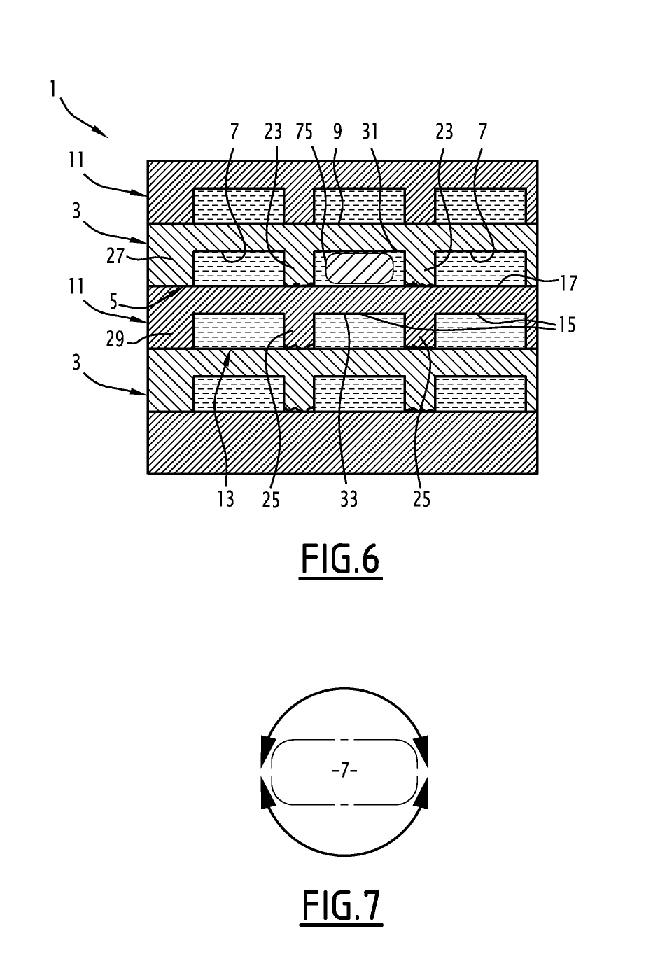

If, as illustrated in FIG. 6, the isthmuses 23, 25 or the rims or edges 27, 29 are not linked to the plates by a perfectly continuous weld joint, the eddy currents are not able to circulate around the primary or secondary channels, as illustrated in FIG. 7. The testing by means of eddy currents is not possible. It is indeed not possible to distinguish in this case between a crack or an initiation of a crack, and a defect or existing discontinuity in the weld joint attaching the plates to each other.

Once the measuring heads are brought back into the interior of the tubes 73, the computer commands the movement of the support 53 along the slide rails 65. It stops the movement of the support 53 when the tubes 73 are situated in the extension of the first ends 47 situated on another row. It then commands a new movement of the measurement heads 75, in a manner so as to inspect and test the primary channels opening in the second row.

The movement of the support is repeated until all of the rows have been tested.

It is to be noted that the welds of the rims of the plates are also tested, when the head 75 is moved in the primary channel delimited by the said rim.

The testing device is then detached from the heat exchanger, and is fixed in a position that allows for the inspection-testing of the primary channels opening on to the top plane surface 45. The sequence of operations to be executed for performing the inspection-testing of the channels opening on to the top plane surface 45 is identical to that described above for top plane surface 43.

It should be noted that the diffusion welding process offers several advantages. Given the fact that the conditions of welding are controlled, the geometry of the cross sections of passages are relatively uniform except in the proximity of some singular zones (edges and corners in particular). The probability of a measurement head getting stuck during the course of its movement along the channel is reduced. However, the geometry of the probes used in the corner zones may be adapted according to the particular geometries of the channels in the singular zones.

Furthermore, this absence of deformation of the plates at the time of assembly makes it possible to obtain top plane surfaces that are rigorously planar and have well controlled dimensions. This facilitates the indexing in position of the testing device relative to the heat exchanger.

What is claimed is:

1-12. (canceled)

13. A testing method for testing the integrity of a heat exchange zone of a plate heat exchanger, the heat exchanger including a plurality of first plates, each bearing at least one circulation network for the circulation of a first fluid and including of a plurality of first channels for circulation of the first fluid, the heat exchanger also including a plurality of second plates, each bearing at least one circulation network for the circulation of a second fluid and including a plurality of second channels for circulation of the second fluid, the first and second plates being secured to each other alternately in a sealed manner in order to form the heat exchange zone of the heat exchanger, the method comprising:
at least one step of inspection-testing in the course of which eddy current testing probes are moved along the first and/or second channels, the first and second plates being assembled on to each other by diffusion welding in a manner such that at least one of the first or second channels from which the inspection and tests are carried out have continuous perimeters that enable the circulation of the eddy currents around each of the first and second channels in which the testing probes are moved.

14. The method as recited in claim 13 wherein the first or second channels of a same given plate are separated from each other by isthmuses diffusion welded to another plate.

15. The method as recited in claim 13 wherein the inspection-testing step is performed without the first and second plates being disassembled from each other.

16. The method as recited in claim 13 wherein the heat exchanger is mounted in a nuclear reactor, the inspection-testing step being performed in situ.

17. The method as recited in claim 13 wherein the heat exchanger is mounted in a nuclear reactor, the inspection-testing step being carried out under water.

18. The method as recited in claim 13 wherein at least one of the first or second channels each have first and second ends opposite to each other, the heat exchanger having one or more top plane surfaces on which the first ends open.

19. The method as recited in claim 18 wherein the first ends are arranged so as to form on each top plane surface several rows parallel to each other.

20. The method as recited in claim 19 wherein the inspection-testing is performed by making use of an testing device comprising a chassis mounted on to the heat exchanger, and a plurality of probes connected to the chassis, with the probes performing the simultaneous testing of all of at least one of the first or second channels whose first ends are situated on a given row.

21. The method as recited in claim 20 wherein the probes are linked to a support that is movable in relation to the chassis, the support being moved relative to the chassis upon completion of the testing of all of at least one of the first or second channels, whose first ends are situated on a given row, in a manner so as to place the probes in position in order to carry out the testing of all of at least one of the first or second channels whose first ends are situated on another given row.

22. The method as recited in claim 20 wherein the chassis of the testing device is positioned relative to the first ends of at least one of the first or second channels by using positioning indexes formed on each top plane surface.

23. The method as recited in claim 18 wherein the heat exchanger is secured inside a nuclear reactor vessel comprising a shell, a cover and a fastening flange for fastening the cover to the shell, the heat exchanger being disposed in the shell in a manner such that each top plane surface is turned towards the flange.

24. The method as recited in claim 13 wherein at least one of the first or second channels are each delimited by a peripheral wall having, along the entire periphery of the first or second channel, a substantially constant thickness of material.
